(19) United States
(12) Patent Application Publication
(10) Pub. No.: US 2022/0289915 A1
(43) Pub. Date: Sep. 15, 2022

(54) METHOD TO SYNTHESIZE GELATIN METHACRYLOYL HYDROGELS

(71) Applicant: THE UNIVERSITY OF BRITISH COLUMBIA, Vancouver (CA)

(72) Inventors: Mohamed Gamaleldin A. Mohamed, Kelowna (CA); Keekyoung Kim, Kelowna (CA)

(73) Assignee: THE UNIVERSITY OF BRITISH COLUMBIA, Vancouver, BC (CA)

(21) Appl. No.: 17/633,915

(22) PCT Filed: Aug. 7, 2020
(86) PCT No.: PCT/CA2020/051089

§ 371 Date: Feb. 8, 2022

Related U.S. Application Data
(60) Provisional application No. 62/884,408, filed on Aug. 8, 2019.

(51) Int. Cl. C08J 3/075; C08L 89/06

(52) U.S. Cl. CPC C08J 3/075; C08L 89/06; C08J 2389/06

(57) ABSTRACT

A method for synthesizing hydrogels comprises dissolving a gelatin in a first solvent to form a first solution, methacrylating the first solution using a methacrylating agent to form a solution containing dissolved gelatin methacryloyl, precipitating the gelatin methacryloyl from the solution by adding a second solvent and isolating the precipitated gelatin methacryloyl. The method may further comprise dissolving the precipitated gelatin methacryloyl in a third solvent to remove the second solvent.

### BACKGROUND

### 1. Technical Field

This disclosure relates generally to tissue engineering and in particular to a method of synthesizing gelatin methacryloyl hydrogels.

### 2. Description of Related Art

Gelatin Methacryloyl (hereinafter referred to as GelMA) is one of the most widely used hydrogel materials for applications in tissue engineering, stem cell, and cancer research. GelMA provides a biocompatible matrix for 3D cell culturing. However, the synthesis process for GeIMA is time consuming, taking approximately 2 weeks, and poorly reproducible, leading to high batch to batch variations.

With reference to FIG. 1, in a conventional GeIMA synthesis methods, a 10% WN gelatin solution is prepared in either a dimethyl sulfoxide (DMSO) (with a catalyst, such as 4-dimethylaminopyridine) as illustrated generally at 12, or a phosphate buffered saline (PBS) solution as illustrated generally at 14. Thereafter, either glycidyl methacrylate or methacrylic anhydride is added to the mixture of DMSO or PBS in a drop wise manner and then stirred for 48 hours in the case of DMSO, or 1-3 hours in the case of PBS as illustrated generally at 16. After the reaction, the reacted mixture is dialyzed against reverse osmosis (RO) water using dialysis membranes for a week as illustrated generally at 18, during which the water is changed twice a day to remove unreacted toxic chemicals. Subsequently, dried GeIMA is obtained after freeze drying the mixture for another 7 days as illustrated generally at 20.

Such conventional methods of GeIMA are time-consuming and prone to variability with yield ranges varying widely from 18% to 72%. In particular, the requirement to use reverse osmosis for a week followed by a week of freeze drying extends the synthesis time to 2 weeks or more. Furthermore performing the dialysis at relatively warm temperatures (\tilde{−}=40° C.) exposes the protein to degradation risk while carrying out the dialysis at 35 to 40° C. has been previously observed to result in a large reduction of the reaction yield. While dialysis could be performed at 4 ° C. to minimize degradation this may entail an extended dialysis time due to the fact that diffusivity reduces at lower temperatures.

The freeze drying process is also time consuming and ensues high capital equipment costs, which is a primary motivation in minimizing process times. Moreover, freeze drying is well documented to not only cause batch to batch variation but also heterogeneity within batches, which is attributed to fluid-dynamics and radiation. The main hurdles preventing the GeIMA synthesis process from being time efficient, economical and reproducible are therefore the dialysis and freeze-drying steps,

### SUMMARY OF THE DISCLOSURE

According to a first embodiment, there is disclosed a method for synthesizing hydrogels comprising dissolving a gelatin in a first solvent to form a first solution, methacrylating the first solution using a methacrylating agent to form a solution containing dissolved gelatin methacryloyl, precipitating the gelatin methacryloyl from the solution by adding a second solvent and isolating the precipitated gelatin methacryloyl.

The first solvent may have a dielectric constant of less about than 50. The second solvent may have a dielectric constant of less than about 20. The second solvent may have a dielectric constant of less than about 10.

The first and second solvents may be miscible. The first solvent may be selected from the group consisting of dimethyl sulfoxide (DMSO), dimethyl formamide (DMF), dimethyl acetamide, N-methyl-2-pyrrolidone and hexamethylphosphoramide. The methacrylating agent may be a methacrylate group donor. The methacrylating agent may comprise glycidyl methacrylate.

The second solvent may be immiscible with water. The second solvent may be selected from the group consisting of dichloromethane, dichloromethane, butanol, butanone, ethyl acetate, a C5 to C8 alkane or cycloalkane, diethyl ether, carbon tetrachloride, chloroform, benzene, toluene, trichloroethylene, disopropyl ether, methyl-t -butyl ether and butyl acetate. The second solvent may comprise toluene.

Isolating may comprise decanting the supernatant from the gelatin methacryloyl. The method may further comprise washing the gelatin methacryloyl after separation from the supernatant. The gelatin methacryloyl may be washed with the second solvent. The precipitated gelatin methacryloyl may be disolved in a third solvent, wherein the third solvent is immiscible with the second solvent. The method may further comprise removing residues of the second solvent.

The method may further comprise dissolving the gelatin methacryloyl after washing in a water or aqueous buffered solution and removing any non-aqueous phase via evaporation or decanting.

The gelatin may be dissolved in the first solvent at a temperature of about 50 degrees Celsius and above. The methacrylating agent may be added to the first solution in a volume of up to about 18% V/V. A catalyst may be added to the solution along with the methacrylating agent. The catalyst may comprise dimethylaminopyridine.

According to a further embodiment, there is disclosed a hydrogel formed by dissolving a gelatin in a first solvent to form a first solution, methacrylating the first solution using a methacrylating agent to form a solution containing dissolved gelatin methacryloyl, precipitating the gelatin methacryloyl from the solution by adding a second solvent and isolating the precipitated gelatin methacryloyl. The precipitated gelatin methacryloyl may be disolved in a third solvent, wherein the third solvent is immiscible with the second solvent. The method may further comprise removing residues of the second solvent.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is an illustration of a conventional method for synthesizing GeIMA.

FIG. 2 is a block diagram of the process for synthesizing hydrogels according to an exemplary embodiment of the present disclosure.

FIG. 3 is a schematic representation of the process of FIG. 2.

FIG. 4 is an illustrations of the products of the process of FIG. 2.

FIG. 5 is an illustration of the products of the process of FIG. 2 at differing ratios of the second solvent to the first solvent.

FIG. 6 is a table listing potential solvents and their respective properties as considered for the method of FIG. 2.

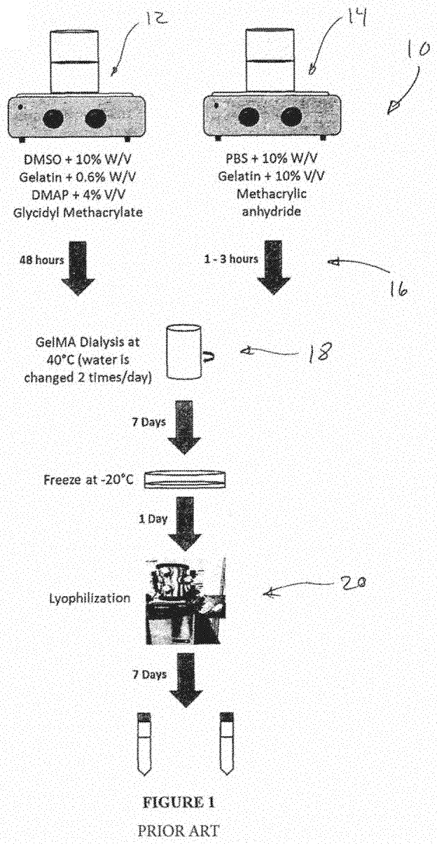

### DETAILED DESCRIPTION

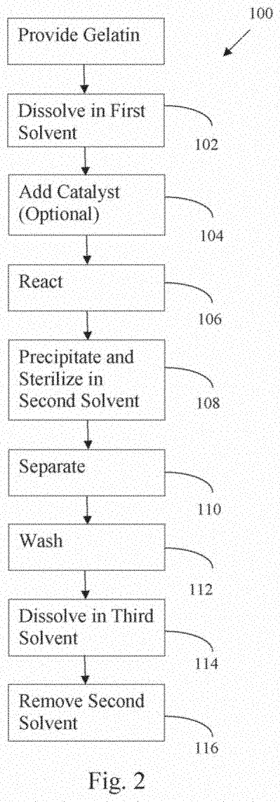

Aspects of the present disclosure are now described with reference to exemplary apparatuses, methods and systems. Referring to FIG. 2, a method for synthesizing GeIMA according to a first embodiment is shown generally at 100. The exemplary method as illustrated in FIG. 2, comprises dissolving a base product in a first solvent to form a first solution at step 102. The first solution is then methacrylated by the addition of a methacrylating agent to form a solution in step 106. Optionally, a catalyst may be introduced to the solution to assist with the methacrylation in step 104. In particular it will be appreciated that the catalyst may be added before or after the methacrylating agent in step 106. Thereafter, the gelatin methacryloyl may be precipitated out of the solution by adding a second solvent in step 108 and then isolated from the solution in step 110. In particular, it will be appreciated that the precipitate from step 108 adheres to the bottom surface of the glass beaker due to the extreme hydrophobicity of toluene which is utilized as the second solvent in the exemplary embodiment while at the same time sterilizing it. Optionally, the GeIMA may be washed in the second solvent at step 112 in an equal volume of fresh toluene and dissolved in a third solvent at step 114, such as by way of non-limiting example water or an aqueous buffered solution, that is immiscible with the second solvent 126 to produce the required GeIMA concentration in step 114. The water will simply dissolve the GeIMA while the lighter volatile toluene will float to the surface and evaporate producing a pure GeIMA solution in step 116. The process of washing may be repeated twice or more times. In particular, the precipitation for storage or use on the bottom of the vessel of GeIMA makes the handling, and washing, of the resultant product much easier such that the supernatant may be simply decanted.

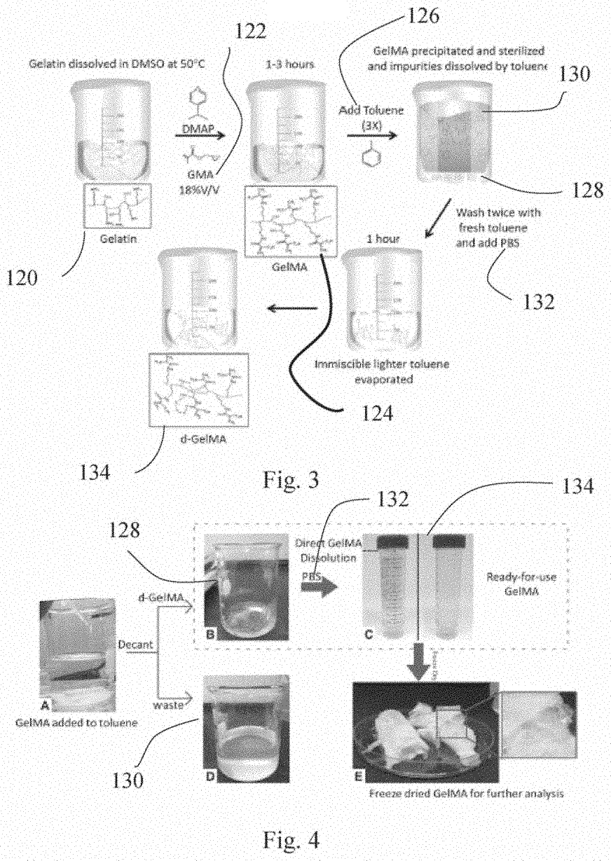

As illustrated in FIG. 3, the gelatin 120 may be provided within any container or vessel as are known and dissolved in the first solvent. After the addition of the methacrylating agent 122, the desired GelMA 124 will be formed in the resulting solution whereupon the addition of the second solvent 126 precipitates the GeIMA 128 out of the solution. The second solvent 126 also dissolves any impurities from the GeIMA precipitate 128 and sterilizes it whereupon the second solvent waste 130 may then be separated from the GeIMA and disposed of by decanting or other separation means, such as by way of non-limiting example, filtering, or centrifuging as well as any other known precipitation separation method, leaving a small amount of the remaining second solvent on the remaining GeIMA. As illustrated in FIGS. 3 and 4, the GelMA precipitate 128 may be dissolved in a third solvent 132 that is immiscible with the second solvent and can dissolve GeIMA such as phosphate buffered saline by way of non-limiting example, while any remaining second solvent 126 will float to the surface to evaporate leaving the purified resultant GelMA solution 134. The resultant product does not need any freeze drying or any other drying process and is dried only if further testing or analysis of the product properties requires that.

The first and second solvents are selected to be miscible with each other as well. In particular, the first solvent will be selected to be operable to dissolve the reaction ingredients, namely the gelatin and methacrylating agent whereas the second solvent is selected to precipitate the reaction products out of the solution such as selecting a second solvent in which the resultant product is insoluble. It will therefore be appreciated that such first and second solvents may vary depending upon the starting base material as well as the methacrylating agents. It will be appreciated that in the present exemplary embodiment, the dielectric constant of the second solvent will be lower than the first solvent to cause such precipitation. Similarly, in oil based embodiments, the dielectric constant of the first solvent will be lower than the second solvent for the same reason.

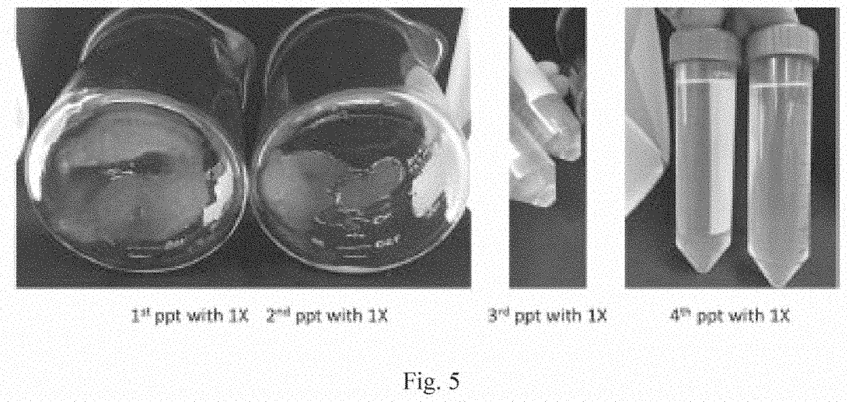

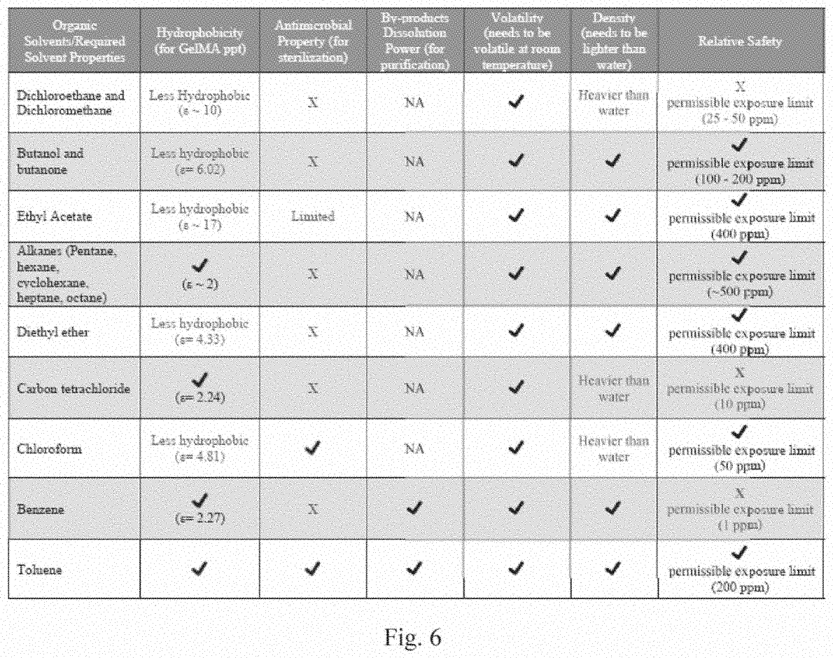

It will be appreciated that although Toluene is described herein as the second solvent, that other solvents may be useful as well. In particular, the second solvent should be selected to be hydrophobic enough (of low dielectric constant) to allow a complete precipitation of the desired product, and therefore also a reproducible yield of GeIMA, which is a hydrophilic protein. The second solvent also desirably includes superior solubility of all the reaction by-products and unreacted chemicals. It will be appreciated that it is advantageous to have strong antibacterial properties to integrate sterilization with the production and purification processes. It is necessary for it to be water immiscible, which is a physical factor that does not allow it to access the hydrophilic GeIMA, and subsequently inhibits protein hydrolysis. Furthermore, the absence of water in the reaction mixture prevents protein denaturation, as proteins denature quicker in the presence of water. Lastly, it is advantageous that the agent be volatile and lighter than the third solvent, such as water by way of non-limiting example to allow for its easy removal by evaporation upon the addition of the final aqueous PBS solution for dissolving GeIMA. In the present exemplary embodiment, Toluene was selected as the organic solvent of choice as it meets all the above mentioned conditions and has also been long known for its superior safety profile for the working personnel over other similar solvents, such as benzene. It will be appreciated that other solvents may also be suitable for use as the second solvent according to the above desired features. It should also be noted that benzene does not show any antimicrobial effects. Furthermore, the ratio of the toluene, or any other second solvent, may be varied so as to increase the yield of the precipitated product. In particular, the second solvent may be utilized in a volume between 1 and 3 times the volume of the first solvent. It will be appreciated that for different first and second solvents, that other ratios may also be useful depending on the solvents and reactants selected. In the case, for the use of DMSO as a first solvent and toluene as a second solvent, it has been found that a production yield of approximately 70% GeIMA has been achieved with a ratio of 1 to 1 of DMSO to toluene. Increasing this ratio to 1 to 2 of DMSO to toluene increased the yield to approximately 90% and 1 to 3 increased the yield to nearly 100%. Ratios beyond 1 to 4 were found to result in no further significant increases in yield. Images of these ratio samples are illustrated in FIG. 5. It will be appreciated that the step-precipitation of the GeIMA is attributed to the mixed properties, such as the length of monomers, that is a characteristic of GeIMA and its gelatin precursor, and the variation in ionic strength that is observed at different volumes of toluene, which also has a low dielectric constant. The large GeIMA protein chains could be precipitated first at relatively higher polarities of the medium as they were heavier and tended to have more hydrophobic interactions that allowed them to settle, thus forming the precipitate. With an additional reduction of medium polarity upon the addition of extra toluene, smaller chains were precipitated. For this reason, various gelatin sources with diverse average molecular weights and bloom numbers will also display varying precipitation behaviors.

In particular, in the present exemplary embodiment, Toluene has three roles in this method:
As a precipitating agent, highly hydrophobic with miscibility in DMSO. It reduces the dielectric constant (polarity) of the solvent of the methacrylation reaction making the GeIMA less soluble, and so precipitates it. Toluene is used to increase the production yield. This is because toluene is extremely hydrophobic with a very low dielectric constant (relative permittivity) (=2) and is better for completely precipitating the GeIMA in high yield at a reduced volume (3×) at room temperature (FIG. 3). Additionally, toluene hydrophobicity protects GelMA against hydrolysis.
As a purifying agent, in which all the reaction impurities and toxic materials are soluble. Toluene is used for its ability of dissolution. All the reaction impurities, most importantly the glycidyl methacrylate and its by-products, and the d-map catalyst have better solubility in toluene than they have in water.
As a sterilizing agent, toluene is bacteriostatic. Toluene has long been recognized for its use as an antimicrobial and as a sterilizing agent. Toluene is a bacteriostatic agent which interferes with the microbial protein production. Examples of other commonly known bacteriostatic antibiotics classes are tetracyclines, sulfonamides, spectinomycin, trimethoprim, chloramphenicol, macrolides and lincosam ides. Therefore toluene is used as disinfecting agent sterilizing the GelMA during the precipitation and the washing steps at room temperature.

With respect to the first solvent, it has been found that low relative permittivity toluene-miscible gelatin aprotic solvents (Dimethyl Sulfoxide, Dimethyl Formamide, Dimethyl Acetamide, etc.) work better with the process of the present disclosure. This is because precipitating from solvents of lower relative permittivity (of around 40) is much easier requiring less reagents volumes and so more efficient. DMSO is miscible with both aqueous and hydrophobic organic solvents. Therefore, it can dissolve the reagents allowing the reaction to happen, while also being removed from the medium easily by adding toluene, in which GelMA is insoluble.

Finally, with respect to the methacrylating agent, glycidyl methacrylate was the selected methacrylate group donor for use with gelatin according to the present disclosure. As set out above, the use of glycidyl methacrylate for forming GeIMA from gelatin is known however, in the present exemplary embodiment, the volume% of glycidyl methacrylate was increased up to 18% VN of the initial gelatin methacrylation reaction mixture to attain a high methacrylation rate ((\tilde{−}75%) in a short time. Advantageously, glycidyl methacrylate is very soluble in toluene and only moderately soluble in water. This makes the elimination of the glycidyl methacrylate easier and instantly thorough, which enables the increase in the volume% of glycidyl methacrylate in the initial methacrylation reaction mixture to fast forward the reaction and reduce the reaction time from 2 days to 2 hours producing a high quality GelMA.

Additionally, this also adds flexibility to the amount of glycidyl methacrylate that can be used without having purification problems. By changing the amount of the added glycidyl methacrylate reagent, the degree of methacrylation can be controlled and subsequently so can all the properties of the resultant GeIMA. This makes it possible to produce different variations of pre-designed GeIMA with different degrees of methacrylation, and mechanical properties.

The precipitate adheres to the bottom surface of the glass beaker due to the extreme hydrophobicity of toluene. This makes the handling, and washing, of the resultant product much easier. The supernatant is simply decanted, and the precipitate is then washed in an equal volume of fresh toluene. The process of washing is repeated twice. Then, PBS is added to produce the required GelMA concentration. The water will simply dissolve the GeIMA while the lighter volatile toluene will float to the surface28 and evaporate producing a pure GeIMA solution. The GeIMA is now ready for use or for packaging.

The exemplary embodiment of the present method, GeIMA was precipitated with a high yield while also ensuring the removal of all other impurities, non-reacted reagents and their by-products by dissolution with simultaneous sterilization. In particular, the results of the above method for producing GeIMA as compared to a conventional process produced the following results:

TABLE 1
Comparison of GelMA Production Methods

| | Dialysis/ | Precipitation |
|---|---|---|
| | Freeze Drying | with Toluene |
| Yield | 60-70% | 99% |
| Production | 2 Weeks | 8 Hours |
| Time | | |
| Production | High | Low |
| Cost | | |
| Reproducibility | Low | High |
| Sterility | No | Yes |

Furthermore, it will be appreciated that due to the ability of toluene, and in particular the antimicrobial and sterilizing properties thereof, that the resulting GeIMA have been found to have a high degree of viability for use in biofabrication.

Although the base material in the present disclosure is utilized as gelatin, it will be appreciated that other materials may also be utilized including, without limitation, collagen of different molecular weights, alginates and hyaluronic acid by way of non-limiting example. The above exemplary embodiments of the present disclosure discusses the present method utilized to form Gelatin Methacryloyl (GeIMA). It will be appreciated that other compositions may also be formed utilizing a similar method, including other hydrogels, bioinks, proteins, saccharides or any other products as well. In particular, more generally, the present method may be utilized to form any substances comprising the steps of dissolving at least one reactant in a first solvent, initiating and conducting the reaction and then precipitating the products in a second solvent. The solvents should be selected to have different dielectric constants so as to facilitate the desired reaction and the subsequent precipitation. Furthermore, the second solvent may be selected to have one or more qualities including, hydrophobicity, antimicrobial properties, byproduct dissolution ability, volatility, density lower than water and relative safety or non-toxicity. More generally, the product of any chemical reaction may be implemented utilizing the above method wherein the first solvent is a compatible medium for the reaction to happen and the second solvent is able to change the polarity (dielectric constant) of the solution in a way to precipitate the intended product. Desirably, all the ingredients of the system including impurities, byproducts, unreacted remaining reactants would also be soluble in the second solvent and the first and second solvents are miscible. Furthermore, a third solvent may be utilized which is immiscible with the second solvent that is used for dissolving the precipitate. A plurality of potential solvents are illustrated in the table illustrated in FIG. 8.

While specific embodiments have been described and illustrated, such embodiments should be considered illustrative only and not as limiting the disclosure as construed in accordance with the accompanying claims.

What is claimed is:

1. A method for synthesizing hydrogels comprising:
dissolving a gelatin in a first solvent to form a first solution;
methacrylating the first solution using a methacrylating agent to form a solution containing dissolved gelatin methacryloyl;
precipitating the gelatin methacryloyl from the solution by adding a second solvent;
isolating the precipitated gelatin methacryloyl.

2. The method of claim 1 wherein the first solvent has a dielectric constant of less about than 50.

3. The method of claim 1 wherein the second solvent has a dielectric constant of less than about 20.

4. The method of claim 3 wherein the second solvent has a dielectric constant of less than about 10.

5. The method of claim 1 wherein the first and second solvents are miscible.

6. The method of claim 1 wherein the first solvent is selected from the group consisting of dimethyl sulfoxide (DMSO), dimethyl formamide (DMF), dimethyl acetamide, N-methyl-2-pyrrolidone and hexamethylphosphoramide.

7. The method of claim 1 wherein the methacrylating agent is a methacrylate group donor.

8. The method of claim 7 wherein the methacrylating agent comprises glycidyl methacrylate.

9. The method of claim 1 wherein the second solvent is immiscible with water.

10. The method of claim 1 wherein the second solvent is selected from the group consisting of dichloroethane, dichloromethane, butanol, butanone, ethyl acetate, a C5 to C8 alkane or cycloalkane, diethyl ether, carbon tetrachloride, chloroform, benzene, toluene, trichloroethylene, diisopropyl ether, methyl-t-butyl ether and butyl acetate.

11. The method of claim 10 wherein the second solvent comprises toluene.

12. The method of claim 1 wherein isolating comprises decanting the supernatant from the gelatin methacryloyl.

13. The method of claim 2 further comprising washing the gelatin methacryloyl after separation from the supernatant.

14. The method of claim 13 wherein the gelatin methacryloyl is washed with the second solvent.

15. The method of claim 1 wherein the precipitated gelatin methacryloyl is disolved in a third solvent, wherein the third solvent is immiscible with the second solvent.

16. the method of claim 15 further comprising removing residues of the second solvent.

17. The method of claim 1 further comprising:
dissolving the gelatin methacryloyl after washing in a water or aqueous buffered solution; and
removing any non-aqueous phase via evaporation or decanting.

18. The method of claim 1 wherein the gelatin is dissolved in the first solvent at a temperature of about 50 degrees Celsius and above.

19. The method of claim 1 wherein the methacrylating agent is added to the first solution in a volume of up to about 18%V/V.

20. The method of claim 1 wherein a catalyst is added to the solution along with the methacrylating agent

21. The method of claim 20 wherein the catalyst comprises dimethylaminopyridine.

22. A hydrogel formed by:
dissolving a gelatin in a first solvent to form a first solution;
methacrylating the first solution using a methacrylating agent to form a solution containing dissolved gelatin methacryloyl:
precipitating the gelatin methacryloyl from the solution by adding a second solvent, and
isolating the precipitated gelatin methacryloyl.

23. The method of claim 22 wherein the precipitated gelatin methacryloyl is disolved in a third solvent, wherein the third solvent is immiscible with the second solvent.

24. The method of claim 23 further comprising removing residues of the second solvent.
